(19) United States
(12) Patent Application Publication
(10) Pub. No.: US 2017/0120338 A1
(43) Pub. Date: May 4, 2017

(54) ADDITIVE MANUFACTURING PART IDENTIFICATION METHOD AND PART

(71) Applicants: Frederik Goeing, Wathlingen (DE); Christoph Wangenheim, Hemmingen (DE); Gunnar Michaelis, Hambuhren (DE)

(72) Inventors: Frederik Goeing, Wathlingen (DE); Christoph Wangenheim, Hemmingen (DE); Gunnar Michaelis, Hambuhren (DE)

(73) Assignee: BAKER HUGHES INCORPORATED, Houston, TX (US)

(21) Appl. No.: 14/930,118

(22) Filed: Nov. 2, 2015

(51) Int. Cl. B22F 3/24; G09F 3/00; B29C 67/00; B29C 71/00; B22F 7/02; B22F 3/105

(52) U.S. Cl. CPC B22F 3/24; B22F 7/02; B22F 3/1055; B29C 67/0081; B29C 71/00; G09F 3/00; B33Y 10/00

(57) ABSTRACT

A part including a material of the part having a first material property. A second material property of the first material or a different material, one of the first material property or the second material property being arranged to form a mark. A method for producing a part.

### BACKGROUND

Oftentimes it is of value to manufacturers to mark their own products in ways that might be difficult to reproduce so that counterfeit products may be more easily identified through the absence of the correct indicia. Various marking methods have been used over the centuries, usually on the surface of the particular product, using paint, stain, stamps, etching (e.g. mechanical or laser), sand blasting using a mask, etc. Each of these has been used with various degrees of success in connection with both durability of the mark and thwarting a prospective counterfeiter.

Marking being what it is, the arts employing the same have been limited to the surface of the part for most marking other than producing product in a certain color or the like. This means that there is a potential risk for surface marks to be removed either intentionally or naturally through shipping interactions or use of the product. Once the mark is gone, it is not often possible to easily discern whether the product is genuine or a fake without specific interrogation of the product. Inquiries necessary where marks are not available leads to unfavorable and unfriendly outcomes with customers and hence is preferably avoided.

In addition to the foregoing drawback of traditional marking, with ever increasing technological advancement, copying of others indicia (and of the products themselves) is increasingly within the grasp of many counterfeiters making counterfeit products more ubiquitous. As a consequence manufacturers are more receptive than ever to new methods of marking their products.

### BRIEF DESCRIPTION

A part including a material of the part having a first material property; a second material property of the first material or a different material, one of the first material property or the second material property being arranged to form a mark.

A method for producing a part includes supplying a feed material to an additive manufacturing device; running a program of the device to additively manufacture the part; producing a first material property; producing a second material property distinct from the first material property

### BRIEF DESCRIPTION OF THE DRAWINGS

The following descriptions should not be considered limiting in any way. With reference to the accompanying drawings, like elements are numbered alike:

FIG. 1 is a schematic view of a piece of material having a specific pattern of density therein (a gradient in this case); and

FIG. 2 is a fanciful representation of a piece of material with a density produced mark configured as “BHI”.

### DETAILED DESCRIPTION

A detailed description of one or more embodiments of the disclosed apparatus and method are presented herein by way of exemplification and not limitation with reference to the Figures.

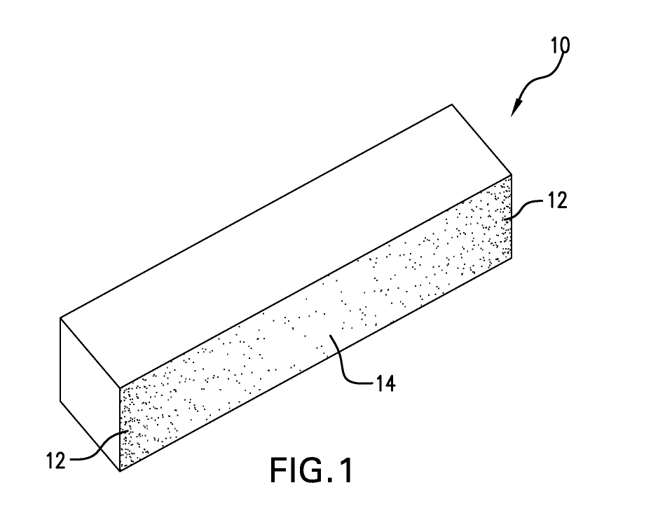

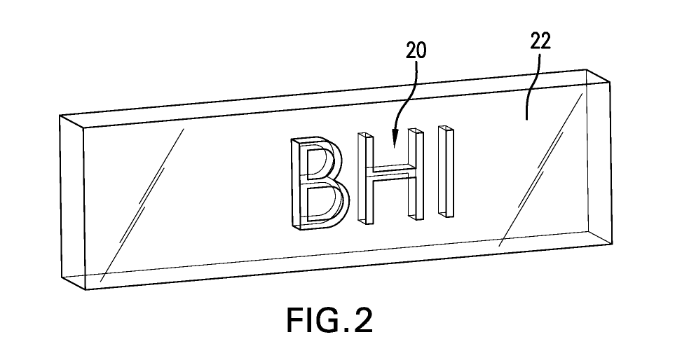

Referring to FIG. 1, a part 10 having a change in material property that is directed at the manufacturing stage is illustrated. In the particular embodiment the property change is in density. It is to be understood however that the property may also be thermal conductivity, electrical conductivity, porosity, magnetic permeability, and combinations including one or more of the foregoing, for example. While in some embodiments the change in material property is entirely subsurface of the part manufactured and therefore not at all visible by the human eye at the surface of the product, the change in property may also be at surface or both at surface and subsurface of the part manufactured, if desired. In connection with the illustration of FIG. 1, it is noted that in order to ensure understanding of the concept disclosed herein the Figure provides a view of a manufactured part with its internal density gradient shown. The gradient is three dimensional and of gradually decreasing density from a surface 12 of the part 10 to a center 14 of the part 10 where the density is least in this embodiment. Referring to FIG. 2, the density changed material is configured to form the letters BHI in three dimensions within the material of the manufactured part.

The part 10 is created in one embodiment using an additive manufacturing process such as Direct Metal Laser Melting or Direct Metal Laser Sintering, or electron beam melting, for example. DMLM is a powder bed additive manufacturing process that builds solid parts from three dimensional CAD (Computer Aided Design) models. The process enables layer upon layer deposition at selected density (for example) levels for each layer or each portion of a layer. Other additive manufacturing processes capable of producing parts contemplated herein include powder feed and wire feed processes. Additive manufacturing processes are known to the art and require no specific discussion in connection with this disclosure.

In each of the additive manufacturing processes noted above (or others functioning similarly) one of the operating parameters of the process will be modified to produce a material property in a location within the manufactured part that is different than that material property elsewhere in the manufactured part.

In order to change properties of the material in the discrete selected areas, changes in one or more parameters of additive manufacturing processes used to create the material may be made. These changes include but are not limited to: varying the energy applied to the feed material by the energy source e.g. laser or electron beam (varying the energy source power including zero power, varying the energy source focus, varying the energy source scanning speed, varying the energy source line spacing) or varying the feed material itself may be employed. More specifically, with respect to energy applied, the energy source being employed, whether e.g. 200, 400, 1000 W or any other energy source power, may be reduced in power at the selected location to reduce the melting of the powdered (or other type) feed material. Reduction in the amount of melt will change the density of the manufactured part in locations where melting was reduced or eliminated in the case of zero power (which will simply leave feed material unaltered, e.g. still powdered). Alternatively, one may change the energy source focus, which also changes the energy applied to the feed material. Further, another alternative is to change the laser energy source scanning speed to alter the energy imparted to the feed material in certain locations. Varying the line spacing of the scanning energy source results in altered porosity or density of the manufactured part in locations where line spacing diverges from otherwise normal line spacing for the part. Causing line spacing to become larger will result in a lower density and greater porosity manufactured part in those areas in which line spacing is increased. Each of these will change the degree of fusing of the feed material at that location with the surrounding particles of feed material and hence change the density or porosity of the final manufactured product at that location. It is to be understood that other material properties such as thermal conductivity, electrical conductivity, magnetism, etc. may also be altered using processes that change feed materials.

While reducing energy applied is discussed above it is also important to note that energy increase can also be useful in achieving the mark disclosed herein. Increasing energy source power will tend to vaporize the powdered metal thereby leaving porosity. It is also contemplated that the mark may be created as a higher density volume in a lower density material. Reversing the methodologies above enable this embodiment.

Referring back to the other identified method for altering the material properties in a part that does not rely upon energy supplied, the feed material itself may be altered. This may be accomplished by changing the material supplied at a feed head for powdered feed material or by changing the wire composition in a wire feed process. Processes capable of additive manufacturing with different materials include cold gas processes, energy source cladding or direct laser deposition, for example.

Again the properties alterable are not limited to density but rather include any other material properties that are detectable by an inquiry device. These too may be achieved by employing different feed materials in the manufacturing process. For example, it is contemplated that magnetic powder could be employed to create a magnetic mark that can be resolved via Eddy current testing, Magnetic resonance imaging, etc. This may be accomplished using any kind of ferro or para magnetic materials. Differing feed materials may include these and all other metals; plastics such as such as PEEK (polyetheretherketone); and/or ceramics that are applicable to additive manufacturing processes. Potential additional materials include but are not limited to PA12-MD(Al), PA12-CF, PA11, 18 March 300/1.2709, 15-5/1.4540, 1.4404 (316L), Alloy 718, Alloy 625, CoCrMo, UNS R31538, Ti6AI4V and AlSi10Mg, Alloy 945x, 17-4/1.4542, Ni Alloys, Alloy 925, CrMnMoN-steel, CoCr Alloys (Stellite), CoNi Alloy, MP35 or equivalent, 4140, 4145 and WC—Ni or WC—Co all of which are commercially available in the industry. Processes capable of additive manufacturing with different materials include cold gas processes, laser cladding or direct laser deposition, for example.

In each of the foregoing cases except where a zero power energy source option is used, the operator is required to produce at least two models. Using FIG. 2 as an aid, which illustrates a “BHI” 20 within a block 22, the first model is the block with a negative of BHI therein and the second model is the three dimensional shape of BHI in the positive. Accordingly, the additive machine will produce each of the two models at the same time in the same location and the result will be as shown in FIG. 2. In the zero power option, only the first model need be provided since the BHI model will only exist based upon the negative in the block model. It may be filled with feed material having had no processing or in an embodiment may be empty.

While BHI is used to illustrate the mark produced by the method hereof, it is to be appreciated that the mark may be a name, acronym, trademark, serial numbers, specifications, bar code, date of production (could of course be part of bar code), etc. Specifications could include information such as type of material, engineering parameters for the material, etc. Yet still, alignment marks may be built into the product in a subsurface portion of the material so that they do not become damaged or worn off. Such marks would be imaged during use to achieve the indications necessary. Alternatively, a magnetic mark could be used in an automated process that would rely upon magnetic alignment for continuing.

The subsurface location of the mark as disclosed herein makes the mark invisible to the naked eye. An imaging methodology and apparatus is required to resolve the mark such as Thermography, Eddy Current Testing (where the part is a conductive material), resistivity measurement, Ultra Sonic Testing or any other non-destructive method, such as Magnetic Flux Leakage, Computer Tomography and x-ray, for example. Upon query of the part, the imaging methodology detects the mark and can verify authenticity or may be configured to display what the mark looks like or what is contained therein. It is also contemplated however that surface marks and marks that occur partially at surface and otherwise subsurface may be produced by the methods hereof.

Set forth below are some embodiments of the foregoing disclosure:

### Embodiment 1

A part comprising: a material of the part having a first material property; a second material property of the first material or a different material, one of the first material property or the second material property being arranged to form a mark.

### Embodiment 2

The part of embodiment 1 wherein the one of the first material property or the second material property being arranged to form a mark is within the material of the other of the first material property and second material property

### Embodiment 3

The part of embodiment 1 wherein the material is metal, plastic or ceramic.

### Embodiment 4

The part of embodiment 1 wherein the first or second material property is density.

### Embodiment 5

The part of embodiment 1 wherein the first or second material property is thermal conductivity.

### Embodiment 6

The part of embodiment 1 wherein the first or second material property is electrical conductivity.

### Embodiment 7

The part of embodiment 1 wherein the first or second material property is porosity.

### Embodiment 8

The part of embodiment 1 wherein the first or second material property is magnetic.

### Embodiment 9

The part of embodiment 1 wherein the mark is one of subsurface or surface of the part.

### Embodiment 10

The part as of embodiment 1 wherein the mark is invisible to a human eye at a surface of the part.

### Embodiment 11

The part of embodiment 1 wherein the mark is partly visible to a human eye at a surface of the product.

### Embodiment 12

The part of embodiment 1 wherein the mark is detectable using an imaging technology.

### Embodiment 13

The part of embodiment 12 wherein the imaging technology is one of thermography, eddy current testing, ultrasonic testing, magnetic resonance imaging, Magnetic Flux Leakage, Computer Tomography and x-ray

### Embodiment 14

The part of embodiment 1 wherein the mark is three dimensional.

### Embodiment 15

The part of embodiment 1 wherein the mark is selected from the group consisting of a name, acronym, trademark, serial numbers, specifications, bar code, and date of production.

### Embodiment 16

A method for producing a part comprising: supplying a feed material to an additive manufacturing device; running a program of the device to additively manufacture the part; producing a first material property; producing a second material property distinct from the first material property.

### Embodiment 17

The method of embodiment 16 wherein the producing of the first material property distinct from the second material property is by varying energy applied to the feed material by an energy source at discrete areas that are to have one of the first material property and the second material property.

### Embodiment 18

The method of embodiment 16 wherein the varying is varying power.

### Embodiment 19

The method of embodiment 16 wherein the varying is varying focus.

### Embodiment 20

The method of embodiment 16 wherein the varying is varying scanning speed.

### Embodiment 21

The method of embodiment 16 wherein the varying is varying line spacing.

### Embodiment 22

The method of embodiment 16 wherein the producing of the first material property distinct from the second material property is by varying feed material at discrete areas that are to have one of the first material property and the second material property.

### Embodiment 23

The method of embodiment 16 wherein the varying is changing the material supplied at a feed head for powdered feed material or by changing the wire composition in a wire feed process

### Embodiment 24

The method of embodiment 16 wherein the producing of the first material property distinct from the second material property is by varying an ultrasonic welding or kinetic energy process at discrete areas that are to have one of the first material property and the second material property.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A part comprising:
a material of the part having a first material property;
a second material property of the first material or a different material, one of the first material property or the second material property being arranged to form a mark.

2. The part as claimed in claim 1 wherein the one of the first material property or the second material property being arranged to form a mark is within the material of the other of the first material property and second material property.

3. The part as claimed in claim 1 wherein the material is metal, plastic or ceramic.

4. The part as claimed in claim 1 wherein the first or second material property is density.

5. The part as claimed in claim 1 wherein the first or second material property is thermal conductivity.

6. The part as claimed in claim 1 wherein the first or second material property is electrical conductivity.

7. The part as claimed in claim 1 wherein the first or second material property is porosity.

8. The part as claimed in claim 1 wherein the first or second material property is magnetic.

9. The part as claimed in claim 1 wherein the mark is one of subsurface or surface of the part.

10. The part as claimed in claim 1 wherein the mark is invisible to a human eye at a surface of the part.

11. The part as claimed in claim 1 wherein the mark is partly visible to a human eye at a surface of the product.

12. The part as claimed in claim 1 wherein the mark is detectable using an imaging technology.

13. The part as claimed in claim 12 wherein the imaging technology is one of thermography, eddy current testing, ultrasonic testing, magnetic resonance imaging, Magnetic Flux Leakage, Computer Tomography and x-ray

14. The part as claimed in claim 1 wherein the mark is three dimensional.

15. The part as claimed in claim 1 wherein the mark is selected from the group consisting of a name, acronym, trademark, serial numbers, specifications, bar code, and date of production.

16. A method for producing a part comprising:
supplying a feed material to an additive manufacturing device;
running a program of the device to additively manufacture the part;
producing a first material property;
producing a second material property distinct from the first material property.

17. The method as claimed in claim 16 wherein the producing of the first material property distinct from the second material property is by varying energy applied to the feed material by an energy source at discrete areas that are to have one of the first material property and the second material property.

18. The method as claimed in claim 16 wherein the varying is varying power.

19. The method as claimed in claim 16 wherein the varying is varying focus.

20. The method as claimed in claim 16 wherein the varying is varying scanning speed.

21. The method as claimed in claim 16 wherein the varying is varying line spacing.

22. The method as claimed in claim 16 wherein the producing of the first material property distinct from the second material property is by varying feed material at discrete areas that are to have one of the first material property and the second material property.

23. The method as claimed in claim 16 wherein the varying is changing the material supplied at a feed head for powdered feed material or by changing the wire composition in a wire feed process

24. The method as claimed in claim 16 wherein the producing of the first material property distinct from the second material property is by varying an ultrasonic welding or kinetic energy process at discrete areas that are to have one of the first material property and the second material property.
